(19) United States
(12) Patent Application Publication
(10) Pub. No.: US 2011/0194316 A1
(43) Pub. Date: Aug. 11, 2011

(54) SWITCHING POWER SUPPLY DEVICE

(76) Inventor: Naohiko MOROTA, Hyogo (JP)

(21) Appl. No.: 13/020,551

(22) Filed: Feb. 3, 2011

(30) Foreign Application Priority Data
Feb. 9, 2010 (JP) 2010-026847

(51) Int. Cl. H02M 3/335

(52) U.S. Cl. 363/21.17

(57) ABSTRACT

A switching power supply device including: a switching element which performs a switching operation; an output voltage generation circuit; a transformer reset detection circuit which generates a transformer reset signal; a secondary-side on-time signal generation circuit; a feedback control circuit which generates a feedback signal; a switching element drive circuit which controls the switching operation of the switching element according to the feedback signal; and an output voltage correcting signal generation circuit which generates an output voltage correcting signal from the feedback signal and a secondary-side on-time signal, and supplies the output voltage correcting signal to the feedback control circuit.

### BACKGROUND OF THE INVENTION

(1) Field of the Invention

The present invention relates to a switching power supply device which detects and controls a secondary-side output voltage on the primary side of a power transformer.

(2) Description of the Related Art

With conventional switching power supply devices that include a power transformer, it is common to detect an output voltage on the secondary side using a control integrated circuit (IC) or the like provided on the secondary side and to provide feedback to the primary side using a photocoupler.

However, the expensive secondary-side control IC and photocoupler constitute a large part of the cost of the switching power supply device and inhibit miniaturization of the switching power supply device.

In view of such drawbacks, switching power supply devices adopting a primary-side control method have been proposed which detect and control the secondary-side output voltage on the primary side without using the secondary-side control IC and the photocoupler.

An example of such a control method uses, after the switching element provided on the primary side is turned off, an auxiliary winding voltage Vbias which is induced in an auxiliary winding of the power transformer and is proportional to the secondary-side output voltage.

This control method using the auxiliary winding voltage Vbias can be classified into the following two types:

The auxiliary winding voltage Vbias oscillates after the switching element on the primary side is turned off. The first control type is to perform feedback control on a rectified and smoothed auxiliary winding voltage. This control uses, as a feedback signal, the oscillating auxiliary winding voltage Vbias after rectifying and smoothing it with a rectification circuit. The second control type is to perform sampling feedback control on the auxiliary winding voltage. In this control, an optimal voltage of the oscillating auxiliary winding voltage Vbias, which is proportional to the output voltage, is sampled and used as a feedback signal.

Unlike the first control type (the feedback control on the rectified and smoothed auxiliary winding voltage), the second control type (the sampling feedback control on the auxiliary winding voltage) allows, as long as the optimal voltage can be sampled, elimination of the impact of degradation in the precision of detecting the output voltage using a resistance component of a rectifier diode provided on the secondary side and the impact of a voltage spike that occurs in the auxiliary winding voltage Vbias after the switching element on the primary side is turned off.

However, in devices such as mobile device chargers, an output cable of approximately one meter in length is often connected to a power output unit, and thus when the output current increases, even the use of the above technique cannot prevent a decrease in the output voltage at a terminal of the output cable due to the resistance of the output cable.

Japanese Unexamined Patent Application Publication No. 2007-295761 (hereinafter referred to as Patent Reference 1) and U.S. Pat. No. 7,061,225 (hereinafter referred to as Patent Reference 2) propose techniques of correcting the cable terminal voltage for solving the above problem of the output voltage being dependent on the load due to the output cable.

Patent Reference 1 proposes a technique of suppressing fluctuations of the output voltage and the output current by detecting, from the auxiliary winding voltage Vbias, a secondary-side on-time T2on which is a time period from when the switching element is turned off to when there is no more current flowing on the secondary side of the power transformer, and correcting, according to T2on, an output voltage detection signal or a reference signal which is to be compared with the output voltage detection signal.

Patent Reference 2 proposes a technique of suppressing fluctuations of the output voltage and the output current by converting a switching element current signal into a voltage signal, detecting and holding a peak value of the voltage signal using a peak holding circuit so as to calculate a switching element current peak Idp, and calculating Idp×T2on using a multiplying circuit.

Assuming Isp as a peak of the current flowing through the secondary winding of the power transformer, an output current Io applied to a terminal of the output cable of the switching power supply device can be given as follows:

Io=½×Isp×T2on/T (Equation 1)

By further using the switching element current peak Idp and a ratio n between the number of turns of the primary winding of the power transformer and the number of turns of the secondary winding of the power transformer, Io can be given also as follows:

Io=½×n×Idp×T2on/T (Equation 2)

Patent Reference 2 proposes that measuring Idp×T2on according to Equation 2 enables highly precise detection of the output current.

### SUMMARY OF THE INVENTION

The technique of Patent Reference 1 is effective to a certain degree in the case where T2on varies according to a switching element current peak Idp and the oscillation cycle T of the switching element is fixed as in the case of the pulse width modulation (PWM) control. However, the technique of Patent Reference 1 does not produce a sufficient effect in the case where the switching element current peak Idp is fixed as in the case of the pulse frequency modulation (PFM) control, because T2on remains almost the same even when the output current changes.

With Patent Reference 2 as well, the oscillation cycle T of the switching element is a fixed value, thereby making it possible to detect the output current with high precision according to Equation 2 in the case where the switching element current peak Idp changes and T2on varies accordingly as in the case of a switching power supply device performing the PWM control. However, there is a problem that application of the technique of Patent Reference 2 to a switching power supply device performing the PFM control does not enable precise detection of the output current, because Patent Reference 2 does not take into account the case where, as in case of the PFM control, the switching element current peak Idp is fixed and the oscillation cycle T is variable according to the load.

When a switching power supply device is taken into account which switches between the PWM control and the PFM control according to the load, the correction of the cable terminal voltage using the output current detection method disclosed in Patent References 1 and 2 enables precise detection of the output current and correction of the output voltage at the output cable terminal while the PWM control is performed as shown in FIG. 12. However, when the PFM control is performed, the output current cannot be precisely detected and almost no correction effect can be obtained, resulting in a problem of a decrease in the output voltage at the output cable terminal when the output current increases.

In order to solve the above problems, the present invention aims to provide a switching power supply device capable of suppressing the fluctuations of the output voltage in both the PWM control and the PFM control.

The switching power supply device according to an aspect of the present invention conceived to solve the above problems is a switching power supply device which converts an input voltage into a desired direct-current voltage and outputs the direct-current voltage, the switching power supply device including: a power transformer including a primary winding, a secondary winding, and an auxiliary winding; a switching element which is connected to the primary winding and performs a switching operation to repeatedly supply and stop supplying a first direct-current voltage to the primary winding; an output voltage generation circuit which converts, into a second direct-current voltage, an alternating-current voltage induced in the secondary winding through the switching operation of the switching element, and supplies the second direct-current voltage to a load; a transformer reset detection circuit which monitors a voltage signal of the auxiliary winding and generates a transformer reset signal according to a decrease in the voltage signal of the auxiliary winding which occurs when a secondary-side current finishes flowing through the secondary winding; a secondary-side on-time signal generation circuit which generates a secondary-side on-time signal indicating a secondary-side on-time that is a time period from when the switching element is turned off to when the transformer reset signal is generated; a feedback control circuit which generates a feedback signal corresponding to a voltage level of the second direct-current voltage; a switching element drive circuit which controls the switching operation of the switching element according to the feedback signal; and an output voltage correcting signal generation circuit which generates an output voltage correcting signal from the feedback signal and the secondary-side on-time signal, and supplies the output voltage correcting signal to the feedback control circuit.

With this configuration, in both the PWM control and the PFM control, (i) generation of the output voltage correcting signal by precisely detecting the output current using the feedback signal and the secondary-side on-time signal and (ii) supply of the generated output voltage correcting signal to the feedback control circuit enable correction of a voltage drop caused by a resistance component of the output cable connected on the secondary side, thereby making it possible to suppress the fluctuations of the output voltage at a terminal of the output cable of the switching power supply device.

Here, the switching power supply device may switch between pulse width modulation (PWM) control by which a switching element current peak of the switching element varies and pulse frequency modulation (PFM) control by which a switching frequency of the switching element varies.

This configuration enables the switching power supply device to control the output voltage to be constant regardless of the control method.

Here, the switching element drive circuit may control the switching element so that a switching element current peak of the switching element is proportional to the feedback signal.

With this configuration, since the switching element current peak of the switching element is controlled to be proportional to the feedback signal, the output current becomes proportional to the output correcting signal, thereby enabling precise detection of the fluctuations of the output current. As a result, the switching power supply device which performs the PWM control can suppress the fluctuations of the output voltage.

Here, the switching element drive circuit may control the switching element so that a switching frequency of the switching element is proportional to the feedback signal.

With this configuration, since the switching frequency of the switching element is controlled to be proportional to the feedback signal, the output current becomes proportional to the output correcting signal, thereby enabling precise detection of the fluctuations of the output current. As a result, the switching power supply device which performs the PFM control can suppress the fluctuations of the output voltage.

Here, the output voltage generation circuit may include the load at an output terminal, and the switching element drive circuit may control the switching element according to a value of the load so that either a switching element current peak or a switching frequency of the switching element is proportional to the feedback signal.

Here, the output voltage generation circuit may include the load at an output terminal, and the switching element drive circuit may control the switching element so that a switching element current peak of the switching element is proportional to the feedback signal when a value of the load is smaller than a predetermined value, and control the switching element so that a switching frequency of the switching element is proportional to the feedback signal when the value of the load is larger than the predetermined value.

This configuration enables a switching power supply device, which switches between the PWM control and the PFM control according to the load provided at a terminal of the output cable, to suppress the fluctuations of the output voltage.

Here, an equation b×fpwm=a×Ipfm may be approximately satisfied, where a is a proportional coefficient of the switching frequency of the switching element with respect to the feedback signal, b is a proportional coefficient of the switching element current peak of the switching element with respect to the feedback signal, Ipfm is the switching element current peak of the switching element when the switching frequency of the switching element is controlled, and fpwm is the switching frequency of the switching element when the switching element current peak of the switching element is controlled.

This configuration enables a switching power supply device, which switches between the PWM control and the PFM control according to the load provided at a terminal of the output cable, to suppress the fluctuations of the output voltage at the terminal of output cable regardless of the control method, by adjusting the correction coefficient to an optimal condition.

The switching power supply device according to an aspect of the present invention conceived to solve the above problems is a switching power supply device which converts an input voltage into a desired direct-current voltage and outputs the direct-current voltage, the switching power supply device including: a power transformer including a primary winding, a secondary winding, and an auxiliary winding; a switching element which is connected to the primary winding and performs a switching operation to repeatedly supply and stop supplying a first direct-current voltage to the primary winding; an output voltage generation circuit which converts, into a second direct-current voltage, an alternating-current voltage induced in the secondary winding through the switching operation of the switching element, and supplies the second direct-current voltage to a load; a transformer reset detection circuit which monitors a voltage signal of the auxiliary winding and generates a transformer reset signal according to a decrease in the voltage signal of the auxiliary winding which occurs when a secondary-side current finishes flowing through the secondary winding; a secondary-side on-time signal generation circuit which generates a secondary-side on-time signal indicating a secondary-side on-time that is a time period from when the switching element is turned off to when the transformer reset signal is generated; a feedback control circuit which generates a feedback signal corresponding to a voltage level of the second direct-current voltage; a switching element drive circuit which controls the switching operation by supplying the switching element with a control signal corresponding to the feedback signal; a switching frequency measuring circuit which generates a switching frequency signal proportional to a switching frequency of the control signal; and an output voltage correcting signal generation circuit which generates an output voltage correcting signal from the switching frequency signal and the secondary-side on-time signal, and supplies the output voltage correcting signal to the feedback control circuit.

With this configuration, in both the PWM control and the PFM control, (i) generation of the switching frequency signal proportional to the switching frequency of the switching element using the feedback signal and the secondary-side on-time signal and (ii) supply of the generated switching frequency signal to the feedback control circuit enable correction of a voltage drop caused by a resistance component of an output cable connected on the secondary side, thereby making it possible to suppress the fluctuations of the output voltage at a terminal of the output cable of the switching power supply device.

The present invention provides a switching power supply device capable of suppressing the fluctuations of the output voltage in both the PWM control and the PFM control.

### Further Information about Technical Background to this Application

The disclosure of Japanese Patent Application No. 2010-026847 filed on Feb. 9, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a switching power supply device according to Embodiment 1 of the present invention;

FIG. 2 is a block diagram showing configurations of an output correcting signal generation circuit and a feedback control circuit included in a switching power supply device according to Embodiment 1 of the present invention;

FIG. 3 is a timing chart showing the operating voltage and the operating current of each component of an output correcting signal generation circuit included in a switching power supply device according to Embodiment 1 of the present invention;

FIG. 4 shows characteristics of the switching frequency, the element current peak, and the output voltage of a switching power supply device according to Embodiment 1 of the present invention;

FIG. 5 is a block diagram showing a configuration of a switching power supply device according to Embodiment 2 of the present invention;

FIG. 6 is a block diagram showing a configuration of a feedback control circuit included in a switching power supply device according to Embodiment 2 of the present invention;

FIG. 7 is a block diagram showing a configuration of the switching power supply device according to Embodiment 3 of the present invention;

FIG. 8 is a block diagram showing a configuration of a feedback control circuit included in a switching power supply device according to Embodiment 3 of the present invention;

FIG. 9 is a block diagram showing a configuration of a switching power supply device according to Embodiment 4 of the present invention;

FIG. 10 is a block diagram showing configurations of an output correcting signal generation circuit and a switching frequency measuring circuit included in a switching power supply device according to Embodiment 4 of the present invention;

FIG. 11 is a timing chart showing the operating voltage of each component of a switching frequency measuring circuit included in a switching power supply device according to Embodiment 4 of the present invention; and

FIG. 12 shows characteristics of the output voltage and the output current of a conventional switching power supply device.

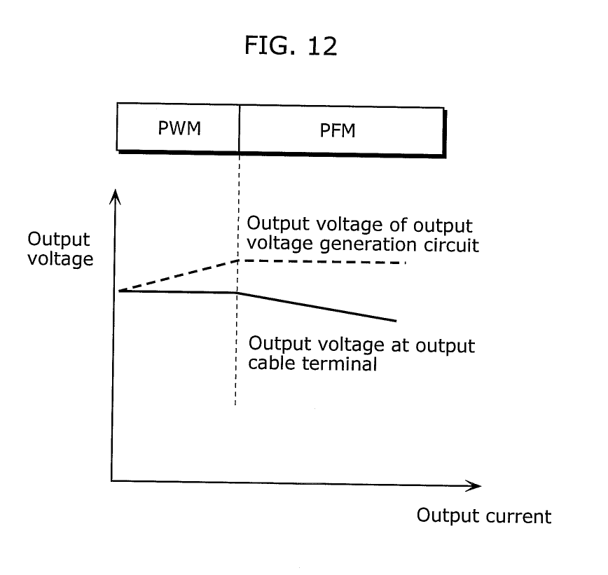

### DESCRIPTION OF THE PREFERRED EMBODIMENT(S)

Hereinafter, embodiments of the present invention are described. Note that although the present invention is described based on the following embodiments and accompanying drawings, the description is provided as a mere example and thus the present invention is not to be limited to such embodiments or drawings.

### Embodiment 1

The switching power supply device according to Embodiment 1 of the present invention is a switching power supply device which converts an input voltage into a desired direct-current voltage and outputs the direct-current voltage, the switching power supply device including: a power transformer including a primary winding, a secondary winding, and an auxiliary winding; a switching element which is connected to the primary winding and performs a switching operation to repeatedly supply and stop supplying a first direct-current voltage to the primary winding; an output voltage generation circuit which converts, into a second direct-current voltage, an alternating-current voltage induced in the secondary winding through the switching operation of the switching element, and supplies the second direct-current voltage to a load; a transformer reset detection circuit which monitors a voltage signal of the auxiliary winding and generates a transformer reset signal according to a decrease in the voltage signal of the auxiliary winding which occurs when a secondary-side current finishes flowing through the secondary winding; a secondary-side on-time signal generation circuit which generates a secondary-side on-time signal indicating a secondary-side on-time that is a time period from when the switching element is turned off to when the transformer reset signal is generated; a feedback control circuit which generates a feedback signal corresponding to a voltage level of the second direct-current voltage; a switching element drive circuit which controls the switching operation of the switching element according to the feedback signal; and an output voltage correcting signal generation circuit which generates an output voltage correcting signal from the feedback signal and the secondary-side on-time signal, and supplies the output voltage correcting signal to the feedback control circuit.

With such a configuration, it is possible to provide a switching power supply device capable of suppressing fluctuations of an output voltage in both the PWM control and the PFM control.

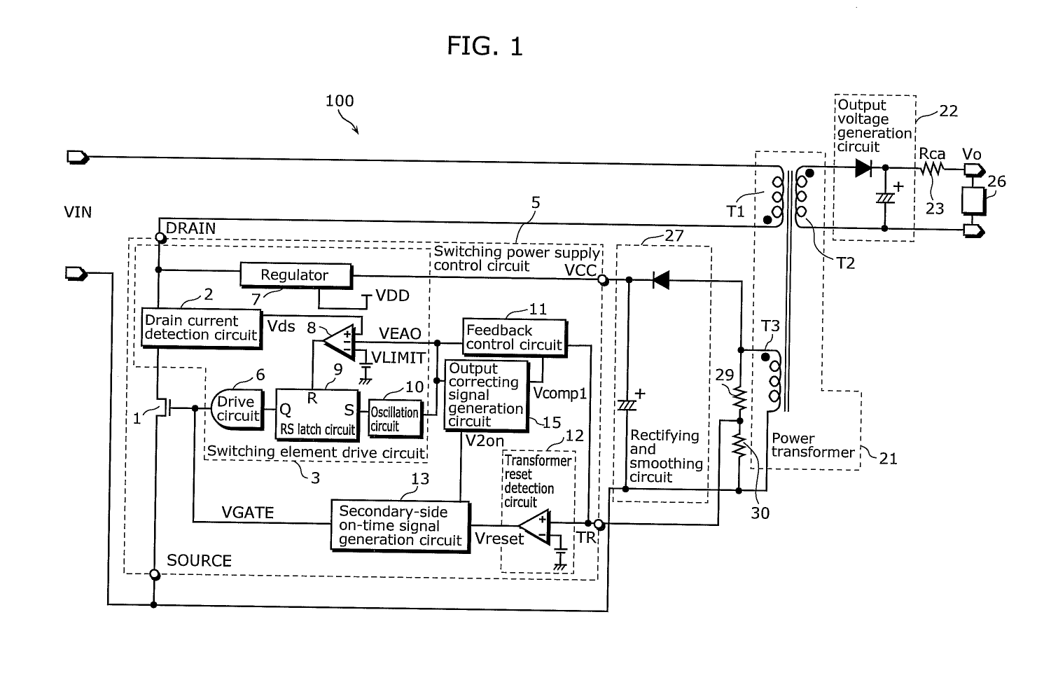

FIG. 1 is a block diagram showing a configuration of a switching power supply device according to Embodiment 1 of the present invention.

In FIG. 1, a switching power supply device 100 includes a switching power supply control circuit 5, a power transformer 21, an output voltage generation circuit 22, an output cable 23 connected to the output voltage generation circuit 22, a load 26 connected to the output cable 23, and a rectifying and smoothing circuit 27. Note that Embodiment 1 describes, as an example of the switching power supply device 100, a switching power supply device which switches between the PFM control and the PWM control according to the load 26.

The power transformer 21 includes a primary winding T1, a secondary winding T2, and an auxiliary winding T3.

The primary winding T1 has one terminal connected to a positive terminal of the switching power supply device 100 on the input side (primary side) and the other terminal connected to a negative terminal of the switching power supply device 100 on the input side (primary side) via a switching element 1.

The secondary winding T2 is connected to the output voltage generation circuit 22 which converts energy induced in the secondary winding T2 of the power transformer 21 into a stable direct-current voltage and supplies the direct-current voltage to the load 26 via the output cable 23.

The auxiliary winding T3 is connected to the rectifying and smoothing circuit 27 which supplies a high-voltage input power to a VCC terminal of the switching power supply control circuit 5.

The switching power supply control circuit 5 includes, for example, the switching element 1 such as a power MOSFET (Metal-Oxide-Semiconductor Field-Effect Transistor), a switching element drive circuit 3, a feedback control circuit 11, a transformer reset detection circuit 12, a secondary-side on-time signal generation circuit 13, an output correcting signal generation circuit 15, and resistors 29 and 30 connected to the auxiliary winding T3.

Here, the switching element 1, the switching element drive circuit 3, the feedback control circuit 11, the transformer reset detection circuit 12, the secondary-side on-time signal generation circuit 13, and the output correcting signal generation circuit 15 are formed on the same semiconductor substrate and constitute the switching power supply control circuit 5. However, the components of the switching power supply control circuit 5 do not necessarily have to be formed on the same semiconductor substrate, and the switching power supply control circuit 5 may include plural components such as discrete components.

The switching power supply control circuit 5 includes four terminals as external terminals, namely: a DRAIN terminal which supplies a drain current to the switching element 1; a VCC terminal which receives a high voltage to be supplied to a regulator 7 provided in the switching element drive circuit 3; a TR terminal which receives an auxiliary winding voltage Vbias from the power transformer 21; and a SOURCE terminal which supplies a source current.

The switching element 1 includes an input terminal, an output terminal, and a control terminal. The input terminal is connected to the DRAIN terminal (the primary winding T1) and the output terminal is connected to the SOURCE terminal (the negative terminal of the switching power supply device 100 on the input side). Furthermore, the switching element 1 performs switching (oscillation) to electrically connect (turn on) or disconnect (turn off) the input terminal and the output terminal in response to a control signal VGATE applied by the switching element drive circuit 3 to the control terminal. By doing so, the switching element 1 repeatedly supplies and stops supplying a first direct-current voltage to the primary winding T1.

The switching element drive circuit 3 includes a drain current detection circuit 2, a drive circuit 6, the regulator 7, a drain current control circuit 8, an RS latch circuit 9, and an oscillation circuit 10.

The drain current detection circuit 2 monitors an element current flowing through the switching element 1, and supplies an element current detection signal Vds to the drain current control circuit 8.

The drain current control circuit 8 compares the element current detection signal Vds with a smaller one of a feedback signal VEAO generated by the feedback control circuit 11 and a reference level VLIMIT, and provides the comparison result to a reset terminal R of the RS latch circuit 9.

The oscillation circuit 10 is connected to the feedback control circuit 11. When the feedback signal VEAO generated by the feedback control circuit 11 is greater than the reference level VLIMIT, the oscillation circuit 10 provides, to a set terminal S of the RS latch circuit 9, a clock signal indicating the oscillation cycle T of the switching element 1 which is adjusted according to the difference between the feedback signal VEAO and the reference level VLIMIT.

The drive circuit 6 converts an output signal provided from an output terminal Q of the RS latch circuit 9 into either a current signal or a voltage signal adequate for controlling the control terminal of the switching element 1. Through this conversion, the drive circuit 6 generates the control signal VGATE that drives the switching element 1.

With this, the switching power supply device 100 performs a current-mode PWM control when the feedback signal VEAO is lower than the reference level VLIMIT, that is, when the load is light, and performs the PFM control when the feedback signal VEAO is higher than the reference level VLIMIT, that is, when the load is heavy.

The regulator 7 is connected to the VCC terminal and the DRAIN terminal and supplies a current to an inner-circuit power supply VDD of the switching power supply control circuit 5 via either the VCC terminal or the DRAIN terminal so as to stabilize, at a constant value, the voltage generated by the inner-circuit power supply VDD.

Note that the VCC terminal in FIG. 1 is connected to the auxiliary winding T3 via the rectifying and smoothing circuit 27 because such connection allows reduction in power consumption of the switching power supply control circuit 5. However, another configuration is also possible in which the VCC terminal is disconnected from the rectifying and smoothing circuit 27 and the auxiliary winding T3 so that the current is supplied to the inner-circuit power supply VDD only via the DRAIN terminal.

The transformer reset detection circuit 12 is connected to the TR terminal and monitors a resistance divided signal obtained by dividing, according to a ratio of the resistance values of the resistors 29 and 30, the auxiliary winding voltage Vbias applied to the TR terminal. The transformer reset detection circuit 12 detects a decrease, to approximately zero, of a secondary-side current Isec flowing through the secondary winding T2 of the power transformer 21, after the switching element 1 is turned off, that is, the transformer reset detection circuit 12 detects a decrease in the auxiliary winding voltage Vbias. Upon detecting the decrease in the auxiliary winding voltage Vbias, the transformer reset detection circuit 12 generates a transformer reset signal Vreset which is a pulse signal.

Note that the present invention can use any one of the following methods for detecting the decrease in the auxiliary winding voltage Vbias: a method using such a comparator as the transformer reset detection circuit 12 of FIG. 1; and a method of detecting, using a differentiating circuit or the like, a point at which the auxiliary winding voltage Vbias starts to decrease. Furthermore, although FIG. 1 shows the TR terminal connected to the auxiliary winding T3 via the resistors 29 and 30, the TR terminal may be directly connected to the auxiliary winding T3 using, for the input side of the transformer reset detection circuit 12, an element having a high dielectric strength.

The secondary-side on-time signal generation circuit 13 is connected to the drive circuit 6 and the transformer reset detection circuit 12, generates a secondary-side on-time signal V2on from the control signal VGATE and the transformer reset signal Vreset, and provides the secondary-side on-time signal V2on to the output correcting signal generation circuit 15.

The output correcting signal generation circuit 15 is connected to the secondary-side on-time signal generation circuit 13 and the feedback control circuit 11 that is connected to the TR terminal.

Here, detailed configurations of the feedback control circuit 11 and the output correcting signal generation circuit 15 are described.

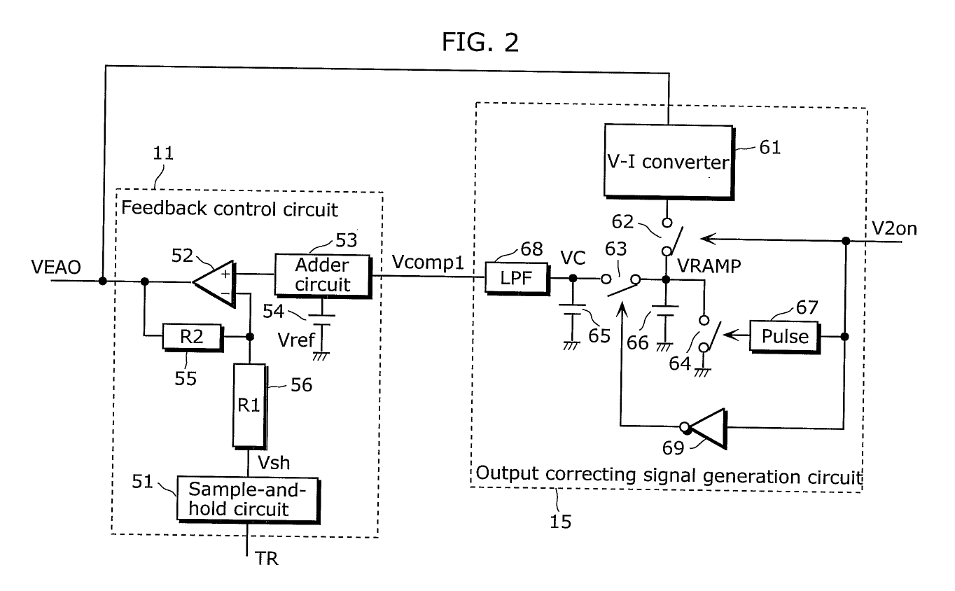

FIG. 2 is a block diagram showing the detailed configurations of the feedback control circuit 11 and the output correcting signal generation circuit 15.

As shown in FIG. 2, the output correcting signal generation circuit 15 includes a V-I converter 61, switches 62, 63, and 64, capacitors 65 and 66, a pulse generation circuit 67, a low-pass filter 68, and an inverter circuit 69.

The V-I converter 61 converts, into a current signal, the feedback signal VEAO generated by the later-described feedback control circuit 11, and supplies the converted feedback signal VEAO to the capacitor 66 via the switch 62.

The switches 62 and 63 are controlled by the secondary-side on-time signal V2on, and the switch 64 is controlled by the pulse generation circuit 67 which generates pulses only when the secondary-side on-time signal V2on rises. Such control allows the capacitor 66 to discharge every time the secondary-side on-time signal V2on rises.

The capacitors 65 and 66 are connected to each other via the switch 63, and the low-pass filter 68 removes high frequency components of a voltage signal VC across the capacitor 65 to generate an output correcting signal Vcomp1.

The feedback control circuit 11 includes a sample-and-hold circuit 51, an operational (OP) amplifier 52, an adder circuit 53, a reference voltage source 54, and resistors 55 and 56.

The sample-and-hold circuit 51 is connected to the negative input terminal of the OP amplifier 52 via the resistor 56.

The resistor 55 is a feedback resistor of the OP amplifier 52.

The sample-and-hold circuit 51 samples and holds a TR terminal voltage at a time when the secondary-side current Isec decreases to approximately zero after the switching element 1 is turned off, so as to generate a TR terminal voltage sampling signal Vsh which serves as an output voltage detection signal.

The adder circuit 53 generates a synthesized reference signal by adding the output correcting signal Vcomp1 provided by the output correcting signal generation circuit 15 and a reference signal Vref.

With such a configuration, the OP amplifier 52 generates the feedback signal VEAO by (i) comparing the synthesized reference signal generated by the adder circuit 53 with the TR terminal voltage sampling signal Vsh serving as the output voltage detection signal and (ii) amplifying the synthesized reference signal.

In other words, the switching power supply device 100 according to Embodiment 1 is a switching power supply device which performs the sampling feedback control on the auxiliary winding voltage.

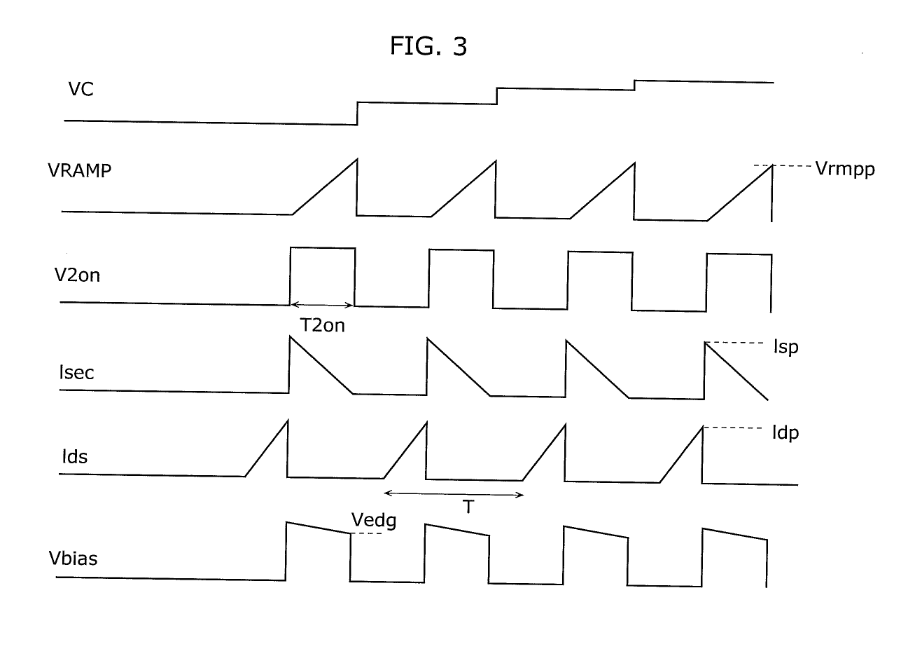

FIG. 3 is a timing chart showing the operating voltage and the operating current of each component of the output correcting signal generation circuit 15.

While the switching element 1 is turned on, the switching element current Ids flows through the primary winding T1 of the power transformer 21. When the switching element 1 is turned off, the secondary-side current Isec flows through the secondary winding T2 of the power transformer 21, and the transformer reset detection circuit 12 and the secondary-side on-time signal generation circuit 13 generate the secondary-side on-time signal V2on according to a time period in which the secondary-side current Isec flows.

The voltage sampled by the sample-and-hold circuit 51 is illustrated as Vedg of the auxiliary winding voltage Vbias induced in the auxiliary winding T3.

The switch 62 is turned on only when the secondary-side on-time signal V2on is at high level, and the capacitor 66 generates a rate signal VRAMP which rises with a gradient corresponding to the feedback signal VEAO.

Due to the inverter circuit 69, the switch 63 is turned on only when the secondary-side on-time signal V2on is at low level. With the turning on of the switch 63, a peak value Vrmpp of the rate signal VRAMP across the capacitor 66 is transferred to the capacitor 65 and the voltage signal VC is generated.

The gradient of the rate signal VRAMP which is the waveform of a charge-discharge voltage applied to the capacitor 66 depends on the feedback signal VEAO, and thus the peak value Vrmpp of the rate signal VRAMP can be given as follows:

Vrmpp=A×T2on×VEAO (Equation 3)

Here, A is a proportional constant determined according to the V-I converter 61 and the capacitance value of the capacitor 66, and T2on is a secondary-side on-time which is a time period from when the switching element is turned off to when there is no more current flowing on the secondary side of the power transformer.

The output correcting signal Vcomp1, when seen on a time axis longer than a cut-off frequency of the low-pass filter 68, can be given as follows:

Vcomp1∝Vrmpp (Equation 4)

This leads to the following equation:

Vcomp1∝T2on×VEAO (Equation 5)

On the other hand, when the output voltage is controlled to be constant, the amount of the load at the output terminal of the output voltage generation circuit 22 can be represented by an output current Io.

An output voltage Vo can be given as follows:

Vo=Vedg−Vf−Rca×Io (Equation 6)

Here, Vf is a forward voltage across a rectifier diode included in the output voltage generation circuit 22, and Rca is a resistance component of the output cable 23 provided at the output terminal of the output voltage generation circuit 22.

The switching frequency fosc and the oscillation cycle T of the switching element 1 can be given as follows:

T=1/fosc (Equation 7)

It thus follows from Equations 2 and 7 that the output current Io provided to a terminal of the output cable of the switching power supply device 100 can be given as follows:

Io=½×n×Idp×T2on×fosc (Equation 8)

Here, Idp in Equation 8 is a fixed value in the case of the PFM control. When the switching frequency fosc of the switching element 1 is controlled to be proportional to the feedback signal VEAO, the output current Io can be given as follows using Equations 5 and 8:

Io∝Idp×Vcomp1 (Equation 9)

In the case of the PWM control, the switching frequency fosc of the switching element 1 in Equation 8 is a fixed value. Thus, when a peak Idp of the switching element current Ids is controlled to be proportional to the feedback signal VEAO, the output current Io can be given as follows:

Io∝fosc×Vcomp1 (Equation 10)

That is to say, because the output current Io is proportional to the output correcting signal Vcomp1 in both the PFM control and the PWM control, the output correcting signal Vcomp1 allows precise detection of the fluctuations of the output current Io.

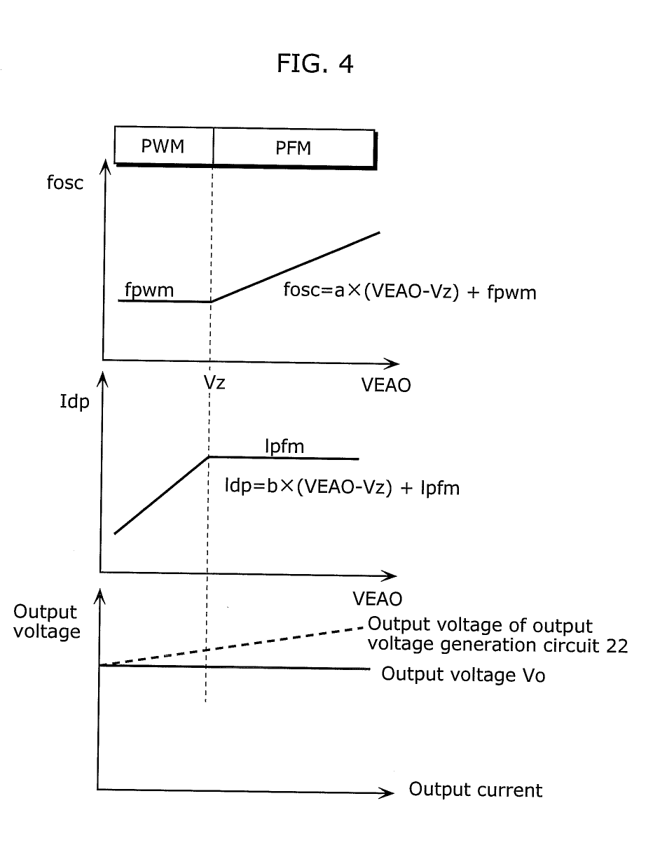

FIG. 4 shows characteristics of the switching frequency, the element current peak, and the output voltage of the switching power supply device 100 that performs both the PWM control and the PFM control to control the switching element 1 and that switches between these two controls according to the feedback signal VEAO, that is, the load 26.

In FIG. 4, assuming that the switching frequency in the PWM control is fpwm and a threshold of the feedback signal VEAO at which the control is switched between the PWM control and the PFM control is Vz, the switching frequency fosc of the switching element 1 in the PFM control can be given as follows:

fosc=a×(VEAO−Vz)+fpwm (Equation 11)

Furthermore, the switching element current peak Idp in the PWM control can be given as follows:

Idp=b×(VEAO−Vz)+Ipfm (Equation 12)

Here, a and b are equivalent to gains of the feedback control that are determined by the feedback control circuit 11 and the oscillation circuit 10.

fpwm is a fixed switching frequency in the PWM control, and Ipfm is a fixed switching element current peak in the PFM control.

It follows that in the PFM control, Equation 8 becomes as follows:

Io=½×n×Ipfm×T2on×[a×(VEAO−Vz)+fpwm] (Equation 13)

In the PWM control, Equation 8 becomes as follows:

Io=½×n×[b×(VEAO−Vz)+Ipfm]×T2on×fpwm (Equation 14)

To enable smooth control over the output voltage characteristics without a point of reverse at the point where the feedback signal VEAO is at the threshold value Vz and the control is switched between the PWM control and the PFM control, the gradient in Equation 13 at the switching point is equal to that in Equation 14.

The following is thus given:

a×Ipfm=b×fpwm (Equation 15)

In other words, by setting the proportional constants a, b, Ipfm, and fpwm to such values that satisfy Equation 15, it is possible to obtain the characteristics of the output voltage at the output cable terminal that are independent of the load 26 even when the control is switched.

Note that in the actual power supply designing, each parameter of Equation 15 does not exactly match Equation 15 in some cases due to a delay time within the switching power supply control circuit 5, an offset voltage of the comparator, or other reasons. However, it is sufficient as long as each parameter approximately satisfies Equation 15.

Although Embodiment 1 of the present invention proposes a switching power supply device which performs both the PFM control and the PWM control and switches between the PFM control and the PWM control according to the load 26, it may be a switching power supply device which performs only one of the PFM control and the PWM control.

Furthermore, Embodiment 1 of the present invention allows not only the switching power supply device adopting the PFM control or the PWM control, to achieve an effect of controlling the output voltage at a terminal of the output cable to be constant, but also the switching power supply device, which performs both the PFM control and the PWM control as shown in FIGS. 1 and 4 and switches between these two control methods according to the feedback signal VEAO, that is, according to the load 26, to achieve an effect of controlling the output voltage to be constant regardless of the control method.

There are two types of the PWM control performed by the switching power supply device. One is a current-mode PWM control by which the switching element current peak is directly controlled as shown in FIG. 1, and the other is a voltage-mode PWM control by which the on-time of the switching element 1 is controlled. Any of these types of the PWM control is acceptable as long as the switching element current peak Idp is controlled to be proportional to the feedback signal VEAO.

### Embodiment 2

Next, the switching power supply device according to Embodiment 2 of the present invention is described. Embodiment 2 is different from Embodiment 1 in that the feedback control circuit of the switching power supply control circuit provided in the switching power supply device includes a subtractor circuit.

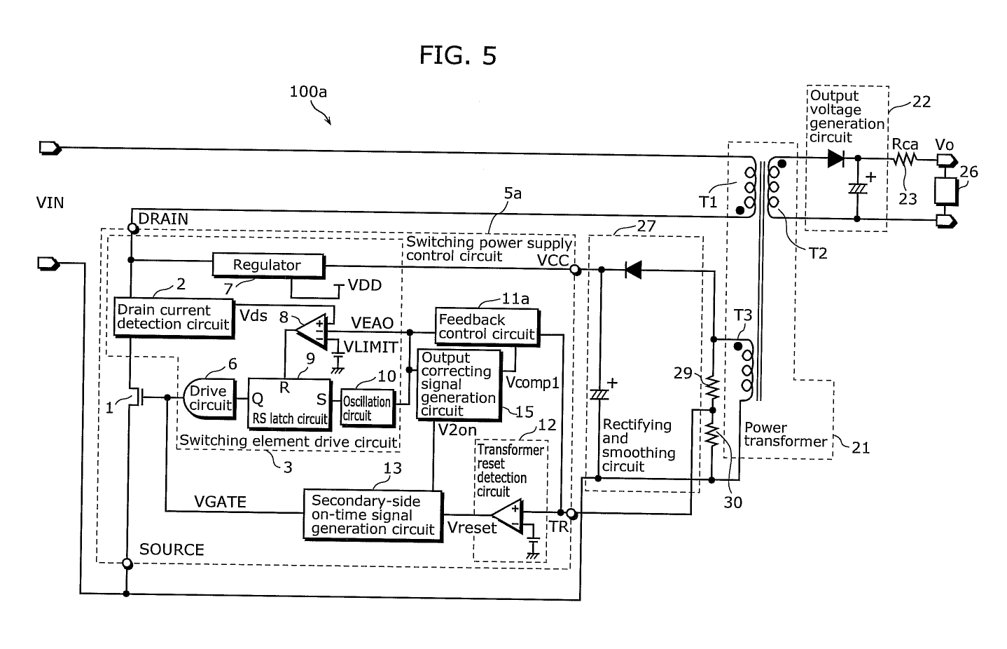

FIG. 5 is a block diagram showing a configuration of the switching power supply device according to Embodiment 2 of the present invention.

In FIG. 5, a switching power supply device 100a includes a switching power supply control circuit 5a, a power transformer 21, an output voltage generation circuit 22, an output cable 23 connected to the output voltage generation circuit 22, a load 26 connected to the output cable 23, and a rectifying and smoothing circuit 27.

As in Embodiment 1, the power transformer 21 includes a primary winding T1, a secondary winding T2, and an auxiliary winding T3. The primary winding T1 has one terminal connected to a positive terminal of the switching power supply device 100a on the input side (primary side) and the other terminal connected to a negative terminal of the switching power supply device 100a on the input side (primary side) via a switching element 1.

The secondary winding T2 is connected to the output voltage generation circuit 22 which converts energy induced in the secondary winding T2 of the power transformer 21 into a stable direct-current voltage and supplies the direct-current voltage to the load 26 via the output cable 23.

The auxiliary winding T3 is connected to the rectifying and smoothing circuit 27 which supplies a high-voltage input power to a VCC terminal of the switching power supply control circuit 5a.

The switching power supply control circuit 5a includes, for example, the switching element 1 such as a power MOSFET, a switching element drive circuit 3, a feedback control circuit 11a, a transformer reset detection circuit 12, a secondary-side on-time signal generation circuit 13, an output correcting signal generation circuit 15, and series resistors 29 and 30 connected to the auxiliary winding T3.

Here, the switching element 1, the switching element drive circuit 3, the feedback control circuit 11a, the transformer reset detection circuit 12, the secondary-side on-time signal generation circuit 13, and the output correcting signal generation circuit 15 are formed on the same semiconductor substrate and constitute the switching power supply control circuit 5a. However, the components of the switching power supply control circuit 5a do not necessarily have to be formed on the same semiconductor substrate, and the switching power supply control circuit 5a may include plural components such as discrete components.

The switching power supply control circuit 5a includes four terminals as external terminals, namely: a DRAIN terminal which supplies a drain current to the switching element 1; a VCC terminal which receives a high voltage to be supplied to a regulator 7 provided in the switching element drive circuit 3; a TR terminal which receives an auxiliary winding voltage Vbias from the power transformer 21; and a SOURCE terminal which supplies a source current.

As in Embodiment 1, the switching element 1 includes an input terminal, an output terminal, and a control terminal. The input terminal is connected to the DRAIN terminal (the primary winding T1) and the output terminal is connected to the SOURCE terminal (the negative terminal of the switching power supply device 100a on the input side). Furthermore, the switching element 1 performs switching (oscillation) to electrically connect (turn on) or disconnect (turn off) the input terminal and the output terminal in response to a control signal VGATE applied by the switching element drive circuit 3 to the control terminal. By doing so, the switching element 1 repeatedly supplies and stops supplying a first direct-current voltage to the primary winding T1.

As in Embodiment 1, the switching element drive circuit 3 includes a drain current detection circuit 2, a drive circuit 6, the regulator 7, a drain current control circuit 8, an RS latch circuit 9, and an oscillation circuit 10.

The drain current detection circuit 2 monitors an element current flowing through the switching element 1, and supplies an element current detection signal Vds to the drain current control circuit 8.

The drain current control circuit 8 compares the element current detection signal Vds with a smaller one of a feedback signal VEAO generated by the feedback control circuit 11a and a reference level VLIMIT, and provides the comparison result to a reset terminal R of the RS latch circuit 9.

The oscillation circuit 10 is connected to the feedback control circuit 11a. When the feedback signal VEAO generated by the feedback control circuit 11a is greater than the reference level VLIMIT, the oscillation circuit 10 provides, to a set terminal S of the RS latch circuit 9, a clock signal indicating the oscillation cycle T of the switching element 1 which is adjusted according to the difference between the feedback signal VEAO and the reference level VLIMIT.

The drive circuit 6 converts an output signal provided from an output terminal Q of the RS latch circuit 9 into either a current signal or a voltage signal adequate for controlling the control terminal of the switching element 1. Through this conversion, the drive circuit 6 generates the control signal VGATE that drives the switching element 1.

With this, the switching power supply device 100a according to Embodiment 2 of the present invention performs the current-mode PWM control when the feedback signal VEAO is lower than the reference level VLIMIT, that is, when the load is light, and performs the PFM control when the feedback signal VEAO is higher than the reference level VLIMIT, that is, when the load is heavy.

The regulator 7 is connected to the VCC terminal and the DRAIN terminal and supplies a current to an inner-circuit power supply VDD of the switching power supply control circuit 5a via either the VCC terminal or the DRAIN terminal so as to stabilize, at a constant value, the voltage generated by the inner-circuit power supply VDD.

Note that the VCC terminal in FIG. 5 is connected to the auxiliary winding T3 via the rectifying and smoothing circuit 27 because such connection allows reduction in power consumption of the switching power supply control circuit 5a. However, another configuration is also possible in which the VCC terminal is disconnected from the rectifying and smoothing circuit 27 and the auxiliary winding T3 so that the current is supplied to the inner-circuit power supply VDD only via the DRAIN terminal.

The transformer reset detection circuit 12 is connected to the TR terminal and monitors a resistance divided signal obtained by dividing, according to a ratio of the resistance values of the resistors 29 and 30, the auxiliary winding voltage Vbias applied to the TR terminal. The transformer reset detection circuit 12 detects a decrease, to approximately zero, of a secondary-side current Isec flowing through the secondary winding T2 of the power transformer 21, after the switching element 1 is turned off, that is, the transformer reset detection circuit 12 detects a decrease in the auxiliary winding voltage Vbias. Upon detecting the decrease in the auxiliary winding voltage Vbias, the transformer reset detection circuit 12 generates a transformer reset signal Vreset which is a pulse signal.

Note that the present invention can use any one of the following methods for detecting the decrease in the auxiliary winding voltage Vbias: a method using such a comparator as that shown in the transformer reset detection circuit 12 of FIG. 5; and a method of detecting, using a differentiating circuit or the like, a point at which the auxiliary winding voltage Vbias starts to decrease. Furthermore, although FIG. 5 shows the TR terminal connected to the auxiliary winding T3 via the resistors 29 and 30, the TR terminal may be directly connected to the auxiliary winding T3 using, for the input side of the transformer reset detection circuit 12, an element having a high dielectric strength.

The secondary-side on-time signal generation circuit 13 is connected to the drive circuit 6 and the transformer reset detection circuit 12, generates a secondary-side on-time signal V2on from the control signal VGATE and the transformer reset signal Vreset, and provides the secondary-side on-time signal V2on to the output correcting signal generation circuit 15.

The output correcting signal generation circuit 15 is connected to the secondary-side on-time signal generation circuit 13 and the feedback control circuit 11a that is connected to the TR terminal.

Here, a detailed configuration of the feedback control circuit 11a is described.

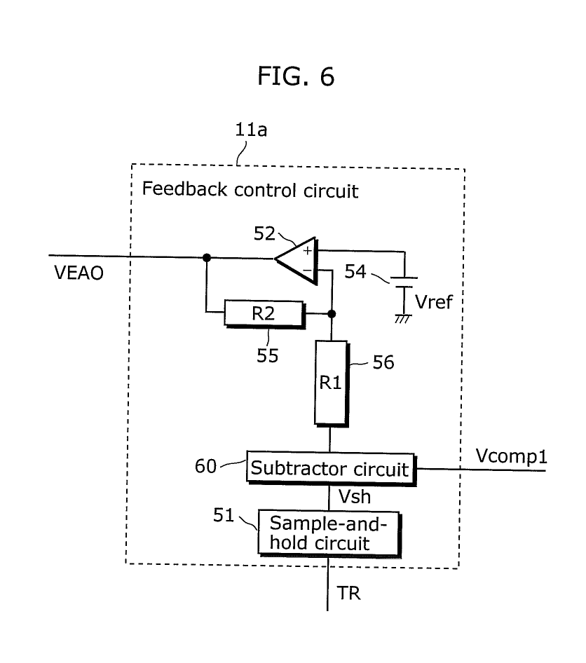

FIG. 6 is a block diagram showing the detailed configuration of the feedback control circuit 11a.

As shown in FIG. 6, the feedback control circuit 11a includes, as in the feedback control circuit 11 of Embodiment 1, a sample-and-hold circuit 51, an operational (OP) amplifier 52, a reference voltage source 54, and resistors 55 and 56. The feedback control circuit 11a further includes a subtractor circuit 60 between the sample-and-hold circuit 51 and the resistor 56.

The sample-and-hold circuit 51 samples and holds a TR terminal voltage at a time when the secondary-side current Isec decreases to approximately zero after the switching element 1 is turned off, so as to generate a TR terminal voltage sampling signal Vsh which serves as an output voltage detection signal.

The subtractor circuit 60 generates a synthesized detection signal by subtracting the output correcting signal Vcomp1 from the TR terminal voltage sampling signal Vsh. The subtractor circuit 60 is connected to the negative input terminal of the OP amplifier 52 via the resistor 56.

The resistor 55 is a feedback resistor of the OP amplifier 52.

With such a configuration, the OP amplifier 52 generates the feedback signal VEAO by (i) comparing the reference signal Vref with the synthesized detection signal which is generated by the subtractor circuit 60 and serves as the output voltage detection signal and (ii) amplifying the reference signal Vref.

That is to say, whereas the switching power supply device 100 of Embodiment 1 has a configuration in which: the adder circuit 53 of the feedback control circuit 11 receives the output correcting signal Vcomp1 and provides, to the OP amplifier 52, the synthesized reference signal generated by adding the output correcting signal Vcomp1 and the reference signal Vref; and the OP amplifier 52 generates the feedback signal VEAO by (i) comparing the synthesized reference signal generated by the adder circuit 53 with the TR terminal voltage sampling signal Vsh serving as the output voltage detection signal and (ii) amplifying the synthesized reference signal, the switching power supply device 100a of Embodiment 2 has a configuration in which: the synthesized detection signal generated by subtracting the output correcting signal Vcomp1 from the TR terminal voltage sampling signal Vsh is provided to the OP amplifier 52; the OP amplifier 52 generates the feedback signal VEAO by (i) comparing the reference signal Vref with the synthesized detection signal generated by subtracting the output correcting signal Vcomp1 from the TR terminal voltage sampling signal Vsh and (ii) amplifying the reference signal Vref.

In other words, the switching power supply device 100a according to Embodiment 2 is a switching power supply device which performs the sampling feedback control on the auxiliary winding voltage.

Note that a description of the output correcting signal generation circuit 15 is omitted because it is the same as that of Embodiment 1 of the present invention.

Although Embodiment 2 of the present invention illustrated in FIGS. 5 and 6 proposes a switching power supply device that switches between the PFM control and the PWM control according to the load, the switching power supply device may only perform either the PFM control or the PWM control.

With such a configuration, Embodiment 2 of the present invention illustrated in FIGS. 5 and 6 allows not only the switching power supply device adopting the PFM control or the PWM control, to achieve an effect of controlling the output voltage at a terminal of the output cable to be constant, but also the switching power supply device, which performs both the PFM control and the PWM control as shown in FIGS. 4 and 5 and switches between these two control methods according to the feedback signal VEAO, that is, according to the load 26, to achieve an effect of controlling the output voltage to be constant regardless of the control method.

There are two types of the PWM control performed by the switching power supply device. One is the current-mode PWM control by which the switching element current peak is directly controlled as shown in FIGS. 1 and 5, and the other is a voltage-mode PWM control by which the on-time of the switching element 1 is controlled. Any of these types of the PWM control is acceptable as long as the switching element current peak Idp is controlled to be proportional to the feedback signal VEAO.

### Embodiment 3

Next, the switching power supply device according to Embodiment 3 of the present invention is described. Embodiment 3 is different from Embodiment 1 in that the feedback control circuit of the switching power supply control circuit provided in the switching power supply device does not include a sample-and-hold circuit and is connected to the VCC terminal.

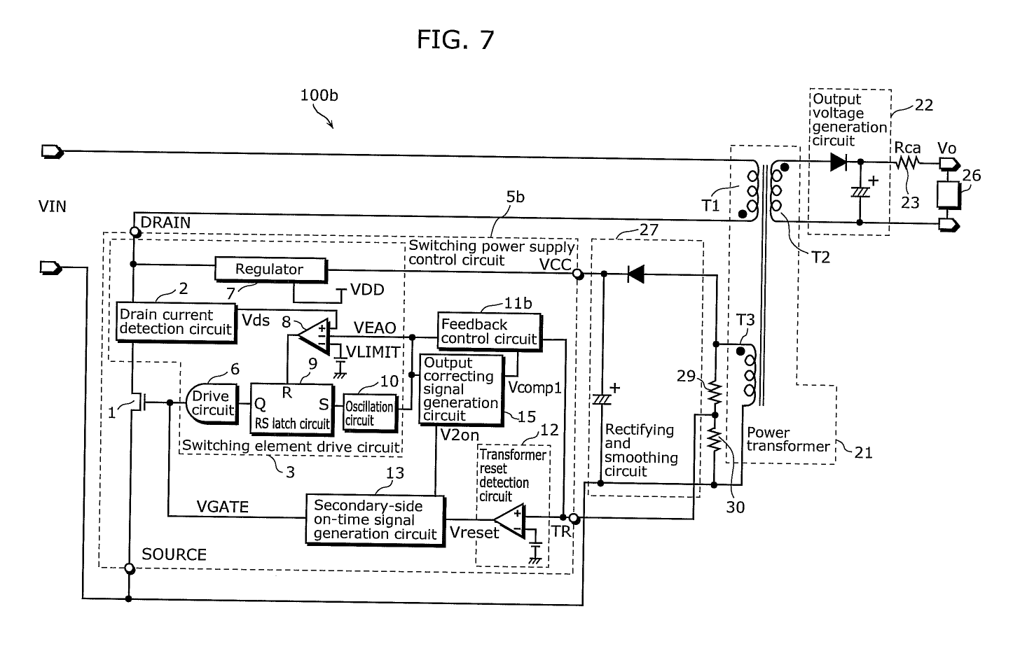

FIG. 7 is a block diagram showing a configuration of the switching power supply device according to Embodiment 3 of the present invention.

In FIG. 7, a switching power supply device 100b includes a switching power supply control circuit 5b, a power transformer 21, an output voltage generation circuit 22, an output cable 23 connected to the output voltage generation circuit 22, a load 26 connected to the output cable 23, and a rectifying and smoothing circuit 27.

As in Embodiment 1, the power transformer 21 includes a primary winding T1, a secondary winding T2, and an auxiliary winding T3. The primary winding T1 has one terminal connected to a positive terminal of the switching power supply device 100b on the input side (primary side) and the other terminal connected to a negative terminal of the switching power supply device 100b on the input side (primary side) via a switching element 1.

The secondary winding T2 is connected to the output voltage generation circuit 22 which converts energy induced in the secondary winding T2 of the power transformer 21 into a stable direct-current voltage and supplies the direct-current voltage to the load 26 via the output cable 23.

The auxiliary winding T3 is connected to the rectifying and smoothing circuit 27 which supplies a high-voltage input power to a VCC terminal of the switching power supply control circuit 5b.

The switching power supply control circuit 5b includes, for example, the switching element 1 such as a power MOSFET, a switching element drive circuit 3, a feedback control circuit 11b, a transformer reset detection circuit 12, a secondary-side on-time signal generation circuit 13, an output correcting signal generation circuit 15, and series resistors 29 and 30 connected to the auxiliary winding T3.

Here, the switching element 1, the switching element drive circuit 3, the feedback control circuit 11b, the transformer reset detection circuit 12, the secondary-side on-time signal generation circuit 13, and the output correcting signal generation circuit 15 are formed on the same semiconductor substrate and constitute the switching power supply control circuit 5b. However, the components of the switching power supply control circuit 5a do not necessarily have to be formed on the same semiconductor substrate, and the switching power supply control circuit 5b may include plural components such as discrete components.

The switching power supply control circuit 5b includes four terminals as external terminals, namely: a DRAIN terminal which supplies a drain current to the switching element 1; a VCC terminal which receives a high voltage to be supplied to a regulator 7 provided in the switching element drive circuit 3; a TR terminal which receives an auxiliary winding voltage Vbias from the power transformer 21; and a SOURCE terminal which supplies a source current.

As in Embodiment 1, the switching element 1 includes an input terminal, an output terminal, and a control terminal. The input terminal is connected to the DRAIN terminal (the primary winding T1) and the output terminal is connected to the SOURCE terminal (the negative terminal of the switching power supply device 100b on the input side). Furthermore, the switching element 1 performs switching (oscillation) to electrically connect (turn on) or disconnect (turn off) the input terminal and the output terminal in response to a control signal VGATE applied by the switching element drive circuit 3 to the control terminal. By doing so, the switching element 1 repeatedly supplies and stops supplying a first direct-current voltage to the primary winding T1.

As in Embodiment 1, the switching element drive circuit 3 includes a drain current detection circuit 2, a drive circuit 6, the regulator 7, a drain current control circuit 8, an RS latch circuit 9, and an oscillation circuit 10.

The drain current detection circuit 2 monitors an element current flowing through the switching element 1, and supplies an element current detection signal Vds to the drain current control circuit 8.

The drain current control circuit 8 compares the element current detection signal Vds with a smaller one of a feedback signal VEAO generated by the feedback control circuit 11b and a reference level VLIMIT, and provides the comparison result to a reset terminal R of the RS latch circuit 9.

The oscillation circuit 10 is connected to the feedback control circuit 11b. When the feedback signal VEAO generated by the feedback control circuit 11b is greater than the reference level VLIMIT, the oscillation circuit 10 provides, to a set terminal S of the RS latch circuit 9, a clock signal indicating the oscillation cycle T of the switching element 1 which is adjusted according to the difference between the feedback signal VEAO and the reference level VLIMIT.

The drive circuit 6 converts an output signal provided from an output terminal Q of the RS latch circuit 9 into either a current signal or a voltage signal adequate for controlling the control terminal of the switching element 1. Through this conversion, the drive circuit 6 generates the control signal VGATE that drives the switching element 1.

With this, the switching power supply device 100b according to Embodiment 3 of the present invention performs the current-mode PWM control when the feedback signal VEAO is lower than the reference level VLIMIT, that is, when the load is light, and performs the PFM control when the feedback signal VEAO is higher than the reference level VLIMIT, that is, when the load is heavy.

The regulator 7 is connected to the VCC terminal and the DRAIN terminal and supplies a current to an inner-circuit power supply VDD of the switching power supply control circuit 5b via either the VCC terminal or the DRAIN terminal so as to stabilize, at a constant value, the voltage generated by the inner-circuit power supply VDD.

Note that the VCC terminal in FIG. 7 is connected to the auxiliary winding T3 via the rectifying and smoothing circuit 27 because such connection allows reduction in power consumption of the switching power supply control circuit 5b. However, another configuration is also possible in which the VCC terminal is disconnected from the rectifying and smoothing circuit 27 and the auxiliary winding T3 so that the current is supplied to the inner-circuit power supply VDD only via the DRAIN terminal.

The transformer reset detection circuit 12 is connected to the TR terminal and monitors a resistance divided signal obtained by dividing, according to a ratio of the resistance values of the resistors 29 and 30, the auxiliary winding voltage Vbias applied to the TR terminal. The transformer reset detection circuit 12 detects a decrease, to approximately zero, of a secondary-side current Isec flowing through the secondary winding T2 of the power transformer 21, after the switching element 1 is turned off, that is, the transformer reset detection circuit 12 detects a decrease in the auxiliary winding voltage Vbias. Upon detecting the decrease in the auxiliary winding voltage Vbias, the transformer reset detection circuit 12 generates a transformer reset signal Vreset which is a pulse signal.

Note that the present invention can use any one of the following methods for detecting the decrease in the auxiliary winding voltage Vbias: a method using such a comparator as that shown in the transformer reset detection circuit 12 of FIG. 7; and a method of detecting, using a differentiating circuit or the like, a point at which the auxiliary winding voltage Vbias starts to decrease. Furthermore, although FIG. 7 shows the TR terminal connected to the auxiliary winding T3 via the resistors 29 and 30, the TR terminal may be directly connected to the auxiliary winding T3 using, for the input side of the transformer reset detection circuit 12, an element having a high dielectric strength.

The secondary-side on-time signal generation circuit 13 is connected to the drive circuit 6 and the transformer reset detection circuit 12, generates a secondary-side on-time signal V2on from the control signal VGATE and the transformer reset signal Vreset, and provides the secondary-side on-time signal V2on to the output correcting signal generation circuit 15.

The output correcting signal generation circuit 15 is connected to the secondary-side on-time signal generation circuit 13 and the feedback control circuit 11b that is connected to the TR terminal.

Here, a detailed configuration of the feedback control circuit 11b is described.

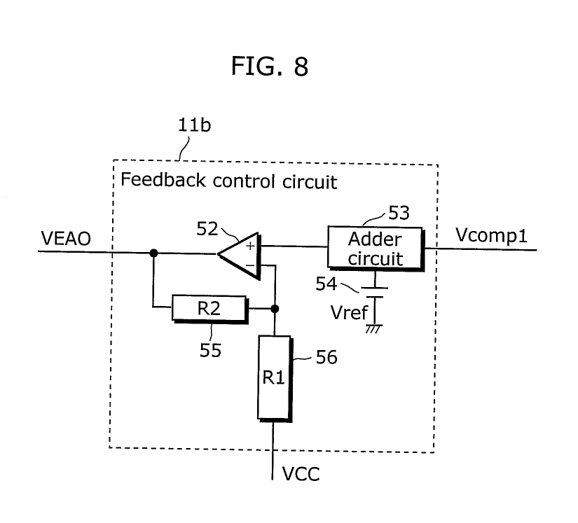

FIG. 8 is a block diagram showing the detailed configuration of the feedback control circuit 11b.

As shown in FIG. 8, similarly to the feedback control circuit 11 of Embodiment 1, the feedback control circuit 11b includes an operational (OP) amplifier 52, an adder circuit 53, a reference voltage source 54, and resistors 55 and 56. The VCC terminal is connected to the negative input terminal of the OP amplifier 52 via the resistor 56. The resistor 55 is a feedback resistor of the OP amplifier 52.

The adder circuit 53 generates a synthesized reference signal by adding the output correcting signal Vcomp1 provided by the output correcting signal generation circuit 15 and a reference signal Vref.

With such a configuration, the OP amplifier 52 generates the feedback signal VEAO by (i) comparing the synthesized reference signal generated by the adder circuit 53 with a VCC terminal voltage serving as the output voltage detection signal and (ii) amplifying the synthesized reference signal.

That is to say, whereas the switching power supply device 100 of Embodiment 1 has a configuration in which: the adder circuit 53 of the feedback control circuit 11 receives the output correcting signal Vcomp1 and provides, to the OP amplifier 52, the synthesized reference signal generated by adding the output correcting signal Vcomp1 and the reference signal Vref; and the OP amplifier 52 generates the feedback signal VEAO by (i) comparing the synthesized reference signal generated by the adder circuit 53 with the TR terminal voltage sampling signal Vsh serving as the output voltage detection signal and (ii) amplifying the synthesized reference signal, the switching power supply device 100b of Embodiment 3 has a configuration in which the OP amplifier 52 receives, not the TR terminal voltage sampling signal Vsh, but a signal of a terminal voltage from the VCC terminal and generates the feedback signal VEAO by (i) comparing the synthesized reference signal generated by adding the output correcting signal Vcomp1 and the reference signal Vref with the signal of the terminal voltage from the VCC terminal and (ii) amplifying the synthesized reference signal.

In other words, the switching power supply device 100b according to Embodiment 3 is a switching power supply device which performs the feedback control on a rectified and smoothed auxiliary winding voltage.

Note that a description of the output correcting signal generation circuit 15 is omitted because it is the same as that of Embodiment 1 of the present invention.

Although Embodiment 3 of the present invention illustrated in FIGS. 7 and 8 proposes a switching power supply device that switches between the PFM control and the PWM control according to the load, the switching power supply device may only perform either the PFM control or the PWM control.

With such a configuration, Embodiment 3 of the present invention illustrated in FIGS. 7 and 8 allows not only the switching power supply device adopting the PFM control or the PWM control, to achieve an effect of controlling the output voltage at a terminal of the output cable to be constant, but also the switching power supply device, which performs both the PFM control and the PWM control as shown in FIGS. 4 and 7 and switches between these two control methods according to the feedback signal VEAO, that is, according to the load 26, to achieve an effect of controlling the output voltage to be constant regardless of the control method.

There are two types of the PWM control performed by the switching power supply device. One is the current-mode PWM control by which the switching element current peak is directly controlled as shown in FIGS. 1 and 7, and the other is a voltage-mode PWM control by which the on-time of the switching element 1 is controlled. Any of these types of the PWM control is acceptable as long as the switching element current peak Idp is controlled to be proportional to the feedback signal VEAO.

FIG. 8 shows the feedback control circuit 11b in which, as in the feedback control circuit 11 of Embodiment 1, the OP amplifier 52 has a positive input terminal connected to the adder circuit which generates the synthesized reference signal by adding up the output correcting signal Vcomp1 and the reference signal Vref, so that the OP amplifier 52 generates the feedback signal VEAO using the VCC terminal voltage provided to the negative input terminal of the OP amplifier 52 as the output voltage detection signal. However, as in the feedback control circuit 11a of Embodiment 2, the OP amplifier 52 may have a negative input terminal connected to a subtractor circuit which generates a synthesized detection signal by subtracting the output correcting signal Vcomp1 from the VCC terminal voltage, so that the OP amplifier 52 generates the feedback signal VEAO by comparing the reference signal Vref with the synthesized detection signal and amplifying the reference signal Vref.

### Embodiment 4

Next, the switching power supply device according to Embodiment 4 of the present invention is described. Embodiment 4 is different from Embodiment 1 in that the switching power supply control circuit provided in the switching power supply device further includes a switching frequency measuring circuit.

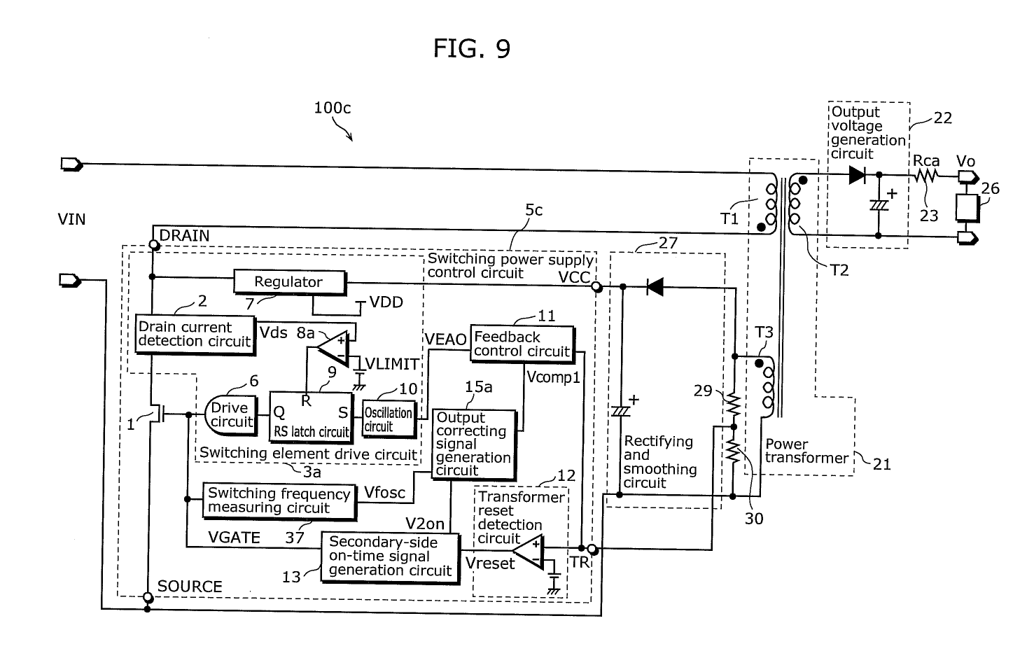

FIG. 9 is a block diagram showing a configuration of the switching power supply device according to Embodiment 4 of the present invention.

A switching power supply device 100c in FIG. 9 includes a switching power supply control circuit 5c, a power transformer 21, an output voltage generation circuit 22, an output cable 23 connected to the output voltage generation circuit 22, a load 26 connected to the output cable 23, and a rectifying and smoothing circuit 27.

As in Embodiment 1, the power transformer 21 includes a primary winding T1, a secondary winding T2, and an auxiliary winding T3. The primary winding T1 has one terminal connected to a positive terminal of the switching power supply device 100c on the input side (primary side) and the other terminal connected to a negative terminal of the switching power supply device 100c on the input side (primary side) via a switching element 1.

The secondary winding T2 is connected to the output voltage generation circuit 22 which converts energy induced in the secondary winding T2 of the power transformer 21 into a stable direct-current voltage and supplies the direct-current voltage to the load 26 via the output cable 23.

The auxiliary winding T3 is connected to the rectifying and smoothing circuit 27 which supplies a high-voltage input power to a VCC terminal of the switching power supply control circuit 5c.

The switching power supply control circuit 5c includes, for example, the switching element 1 such as a power MOSFET, a switching element drive circuit 3a, a feedback control circuit 11, a transformer reset detection circuit 12, a secondary-side on-time signal generation circuit 13, an output correcting signal generation circuit 15a, series resistors 29 and 30 connected to the auxiliary winding T3, and a switching frequency measuring circuit 37.

Here, the switching element 1, the switching element drive circuit 3a, the feedback control circuit 11, the transformer reset detection circuit 12, the secondary-side on-time signal generation circuit 13, the output correcting signal generation circuit 15a, and the switching frequency measuring circuit 37 are formed on the same semiconductor substrate and constitute the switching power supply control circuit 5c. However, the components of the switching power supply control circuit 5c do not necessarily have to be formed on the same semiconductor substrate, and the switching power supply control circuit 5c may include plural components such as discrete components.

The switching power supply control circuit 5c includes four terminals as external terminals, namely: a DRAIN terminal which supplies a drain current to the switching element 1; a VCC terminal which receives a high voltage to be supplied to a regulator 7 provided in the switching element drive circuit 3a; a TR terminal which receives an auxiliary winding voltage Vbias from the power transformer 21; and a SOURCE terminal which supplies a source current.

As in Embodiment 1, the switching element 1 includes an input terminal, an output terminal, and a control terminal. The input terminal is connected to the DRAIN terminal (the primary winding T1) and the output terminal is connected to the SOURCE terminal (the negative terminal of the switching power supply device 100c on the input side). Furthermore, the switching element 1 performs switching (oscillation) to electrically connect (turn on) or disconnect (turn off) the input terminal and the output terminal in response to a control signal VGATE applied by the switching element drive circuit 3a to the control terminal. By doing so, the switching element 1 repeatedly supplies and stops supplying a first direct-current voltage to the primary winding T1.

The switching element drive circuit 3a includes a drain current detection circuit 2, a drive circuit 6, the regulator 7, a drain current control circuit 8a, an RS latch circuit 9, and an oscillation circuit 10.

The drain current detection circuit 2 monitors an element current flowing through the switching element 1, and supplies an element current detection signal Vds to the drain current control circuit 8a.

The drain current control circuit 8a compares the element current detection signal Vds with a reference level VLIMIT, and provides the comparison result to a reset terminal R of the RS latch circuit 9.

The oscillation circuit 10 is connected to the feedback control circuit 11, and provides, to a set terminal of the RS latch circuit 9, a clock signal indicating the oscillation cycle T of the switching element 1 which is adjusted according to the feedback signal VEAO generated by the feedback control circuit 11.

The drive circuit 6 converts an output signal provided from an output terminal Q of the RS latch circuit 9 into either a current signal or a voltage signal adequate for controlling the control terminal of the switching element 1. Through this conversion, the drive circuit 6 generates the control signal VGATE that drives the switching element 1.

The regulator 7 is connected to the VCC terminal and the DRAIN terminal and supplies a current to an inner-circuit power supply VDD of the switching power supply control circuit 5c via either the VCC terminal or the DRAIN terminal so as to stabilize, at a constant value, the voltage generated by the inner-circuit power supply VDD.

Note that the VCC terminal in FIG. 9 is connected to the auxiliary winding T3 via the rectifying and smoothing circuit 27 because such connection allows reduction in power consumption of the switching power supply control circuit 5c. However, another configuration is also possible in which the VCC terminal is disconnected from the rectifying and smoothing circuit 27 and the auxiliary winding T3 so that the current is supplied to the inner-circuit power supply VDD only via the DRAIN terminal.

The transformer reset detection circuit 12 is connected to the TR terminal and monitors a resistance divided signal obtained by dividing, according to a ratio of the resistance values of the resistors 29 and 30, the auxiliary winding voltage Vbias applied to the TR terminal. The transformer reset detection circuit 12 detects a decrease, to approximately zero, of a secondary-side current Isec flowing through the secondary winding T2 of the power transformer 21, after the switching element 1 is turned off, that is, the transformer reset detection circuit 12 detects a decrease in the auxiliary winding voltage Vbias. Upon detecting the decrease in the auxiliary winding voltage Vbias, the transformer reset detection circuit 12 generates a transformer reset signal Vreset which is a pulse signal.

Note that the present invention can use any one of the following methods for detecting the decrease in the auxiliary winding voltage Vbias: a method using such a comparator as that shown in the transformer reset detection circuit 12 of FIG. 9; and a method of detecting, using a differentiating circuit or the like, a point at which the auxiliary winding voltage Vbias starts to decrease. Furthermore, although FIG. 9 shows the TR terminal connected to the auxiliary winding T3 via the resistors 29 and 30, the TR terminal may be directly connected to the auxiliary winding T3 using, for the input side of the transformer reset detection circuit 12, an element having a high dielectric strength.

The secondary-side on-time signal generation circuit 13 is connected to the drive circuit 6 and the transformer reset detection circuit 12, generates a secondary-side on-time signal V2on from the control signal VGATE and the transformer reset signal Vreset, and provides the secondary-side on-time signal V2on to the output correcting signal generation circuit 15a.

The output correcting signal generation circuit 15a is connected to the secondary-side on-time signal generation circuit 13 and the feedback control circuit 11 that is connected to the TR terminal.

The switching frequency measuring circuit 37 is connected to the output correcting signal generation circuit 15a and the control terminal of the switching element 1. The switching frequency measuring circuit 37 generates, from the control signal VGATE applied by the switching element drive circuit 3a to the control terminal, a frequency measuring signal Vfosc which is the inverse of a cycle measuring signal VT, and provides the frequency measuring signal Vfosc to the output correcting signal generation circuit 15a.

Note that a description of the feedback control circuit 11 is omitted because it is the same as that of Embodiment 1 of the present invention.

Here, detailed configurations of the output correcting signal generation circuit 15a and the switching frequency measuring circuit 37 are described.

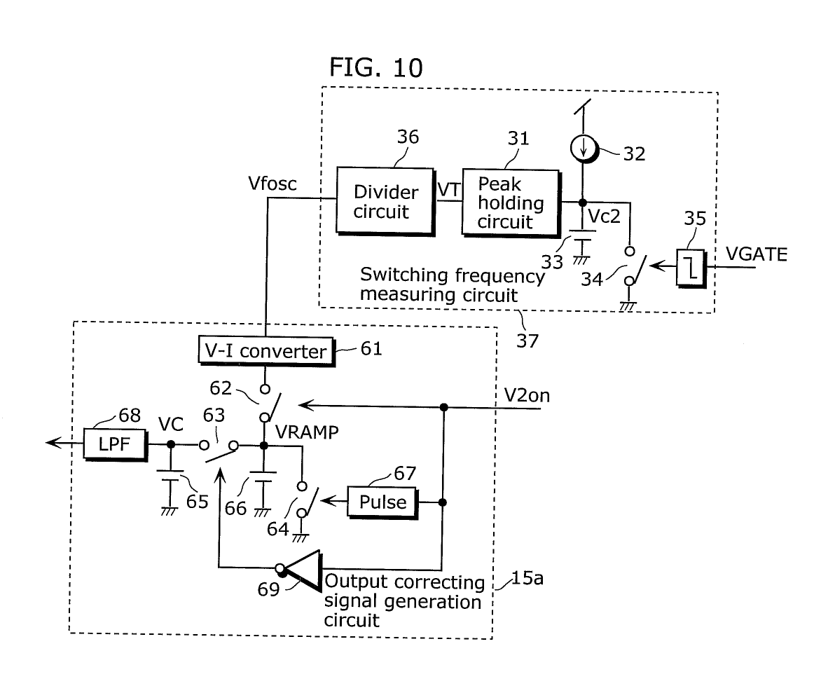

FIG. 10 is a block diagram showing the detailed configurations of the output correcting signal generation circuit 15a and the switching frequency measuring circuit 37.

As shown in FIG. 10, the switching frequency measuring circuit 37 includes a peak holding circuit 31, a constant current source 32, a capacitor 33, a switch 34, a pulse generation circuit 35, and a divider circuit 36.

The capacitor 33 is connected to the constant current source 32, and the switch 34 is controlled by the pulse generation circuit 35. The pulse generation circuit 35 receives the control signal VGATE.

The peak holding circuit 31 is connected to the capacitor 33, and detects and holds a peak voltage of a voltage Vc2 across the capacitor 33 so as to generate a cycle measuring signal VT.

The divider circuit 36 is connected to the peak holding circuit 31 and generates a frequency measuring signal Vfosc which is the inverse of the cycle measuring signal VT.

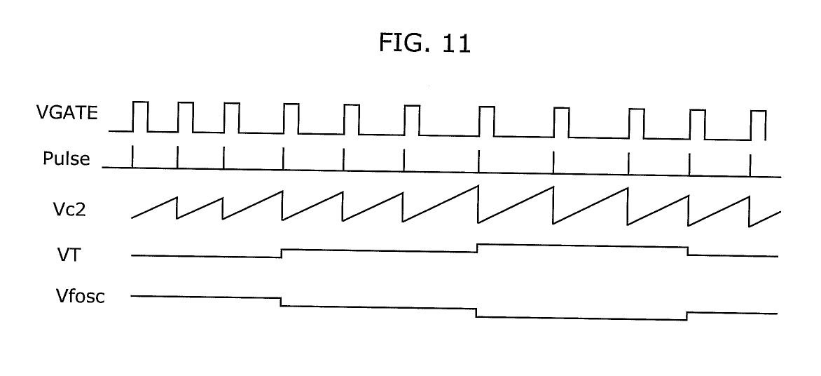

FIG. 11 is a timing chart of the operating voltage of each of the above-described components of the switching frequency measuring circuit 37 shown in FIG. 10.

When the control signal VGATE rises, the pulse generation circuit 35 generates a cycle pulse signal Pulse by which the switch 34 is turned on.

Since the capacitor 33 is charged by the constant current source 32, the voltage Vc2 across the capacitor 33 increases with a constant gradient, and decreases when the charge in the capacitor 33 is discharged through the switch 34 being turned on at every oscillation cycle of the switching element 1 as shown in FIG. 11.

As a result, the peak value of the voltage Vc2 across the capacitor 33 becomes proportional to the oscillation cycle T of the switching element 1, and the cycle measuring signal VT generated by the peak holding circuit 31 also becomes proportional to the oscillation cycle T of the switching element 1. In other words, the longer the oscillation cycle T of the switching element 1 is, the higher the peak value of the voltage Vc2 is and the more the cycle measuring signal VT generated by the peak holding circuit 31 increases.

Since the frequency measuring signal Vfosc generated by the divider circuit 36 is the inverse of the cycle measuring signal VT, the frequency measuring signal Vfosc becomes proportional to the switching frequency of the switching element 1.

A detailed description of the output correcting signal generation circuit 15a is omitted because it is the same as the output correcting signal generation circuit 15 of Embodiment 1 except that the V-I converter 61 receives the frequency measuring signal Vfosc instead of the feedback signal VEAO.

With such a configuration, Embodiment 4 of the present invention illustrated in FIGS. 9 and 10 allows the switching power supply device that performs the PFM control method, to produce an effect of controlling the output voltage at a terminal of the output cable to be constant.

As shown in FIG. 9, although Embodiment 4 of the present invention uses the same feedback control circuit 11 as in Embodiment 1, the feedback control circuit 11a of Embodiment 2 may be used instead.

As shown in FIG. 9, Embodiment 4 of the present invention illustrates an example of the sampling feedback control on the auxiliary winding voltage, in which the feedback control circuit 11 is connected to the TR terminal and an optimal voltage of the auxiliary winding voltage Vbias is sampled to be used as the feedback signal. However, as described in Embodiment 3, the present invention may be applied to the feedback control on a rectified and smoothed auxiliary winding voltage, in which the feedback control circuit 11b is connected to the VCC terminal and a voltage signal obtained by rectifying and smoothing the auxiliary winding voltage Vbias is used as the feedback signal.

Note that the present invention is not limited to the above embodiments. Various modifications and variations are possible within the scope of the present invention.

For example, although, in Embodiment 4, the VCC terminal is connected to the auxiliary winding via the rectifying and smoothing circuit and the voltage induced in the auxiliary winding of the transformer is supplied to the regulator, the VCC terminal may be opened or connected to a capacitor so that the regulator stabilizes, at a constant value, the voltage generated by the inner-circuit power supply VDD included in the switching power supply control circuit. In that case, the regulator may generate the power voltage while constantly having the DRAIN terminal as the input terminal.

Furthermore, the switching power supply device according to the present invention is not limited to the switching power supply device which performs both the PWM control method and the PFM control method, and may be a switching power supply device which performs only one of such control methods. The present invention may also be applied to a switching power supply device which performs not only the PWM control method and the PFM control method but also other methods such as a secondary current on-duty control method and a quasi-resonant control method.

The decrease in the auxiliary winding voltage Vbias may be detected by a method using such a comparator as that shown in the transformer reset detection circuit of Embodiment 1, or by a method of detecting, using a differentiating circuit or the like, a point at which the auxiliary winding voltage Vbias starts to decrease.

There are two types of the PWM control performed by the switching power supply device. One is the current-mode PWM control by which the switching element current peak is directly controlled, and the other is the voltage-mode PWM control by which the on-time of the switching element 1 is controlled. Any of these types of the PWM control is acceptable as long as the switching element current peak Idp is controlled to be proportional to the feedback signal VEAO.

In addition, the present invention also includes: other embodiments achieved through combination of arbitrary constituent elements of the above embodiments; variations achieved through various modifications of the embodiments that a person skilled in the art can conceive without departing from the scope of the present invention; and various devices which include a switching power supply device according to an implementation of the present invention. For example, the present invention also includes a charger and the like which include a switching power supply device according to an implementation of the present invention.

### INDUSTRIAL APPLICABILITY

The switching power supply device according to the present invention can achieve highly precise output voltage characteristics while realizing cost reduction and miniaturization and is useful for power supply devices having an output cable, such as mobile device chargers.

What is claimed is:

1. A switching power supply device which converts an input voltage into a desired direct-current voltage and outputs the direct-current voltage, said switching power supply device comprising:
a power transformer including a primary winding, a secondary winding, and an auxiliary winding;
a switching element which is connected to said primary winding and performs a switching operation to repeatedly supply and stop supplying a first direct-current voltage to said primary winding;
an output voltage generation circuit which converts, into a second direct-current voltage, an alternating-current voltage induced in said secondary winding through the switching operation of said switching element, and supplies the second direct-current voltage to a load;
a transformer reset detection circuit which monitors a voltage signal of said auxiliary winding and generates a transformer reset signal according to a decrease in the voltage signal of said auxiliary winding which occurs when a secondary-side current finishes flowing through said secondary winding;
a secondary-side on-time signal generation circuit which generates a secondary-side on-time signal indicating a secondary-side on-time that is a time period from when said switching element is turned off to when the transformer reset signal is generated;
a feedback control circuit which generates a feedback signal corresponding to a voltage level of the second direct-current voltage;
a switching element drive circuit which controls the switching operation of said switching element according to the feedback signal; and
an output voltage correcting signal generation circuit which generates an output voltage correcting signal from the feedback signal and the secondary-side on-time signal, and supplies the output voltage correcting signal to said feedback control circuit.

2. The switching power supply device according to claim 1,
wherein the switching operation of said switching element switches between pulse width modulation (PWM) control by which a switching element current peak of said switching element varies and pulse frequency modulation (PFM) control by which a switching frequency of said switching element varies.

3. The switching power supply device according to claim 1,
wherein said switching element drive circuit controls said switching element so that a switching element current peak of said switching element is proportional to the feedback signal.

4. The switching power supply device according to claim 1,
wherein said switching element drive circuit controls said switching element so that a switching frequency of said switching element is proportional to the feedback signal.

5. The switching power supply device according to claim 1,
wherein said output voltage generation circuit includes the load at an output terminal, and
said switching element drive circuit controls said switching element according to a value of the load so that either a switching element current peak or a switching frequency of said switching element is proportional to the feedback signal.

6. The switching power supply device according to claim 1,
wherein said output voltage generation circuit includes the load at an output terminal, and
said switching element drive circuit controls said switching element so that a switching element current peak of said switching element is proportional to the feedback signal when a value of the load is smaller than a predetermined value, and controls said switching element so that a switching frequency of said switching element is proportional to the feedback signal when the value of the load is larger than the predetermined value.

7. The switching power supply device according to claim 6,
wherein an equation b×fpwm=a×Ipfm is approximately satisfied,
where a is a proportional coefficient of the switching frequency of said switching element with respect to the feedback signal,
b is a proportional coefficient of the switching element current peak of said switching element with respect to the feedback signal,
Ipfm is the switching element current peak of said switching element when the switching frequency of said switching element is controlled, and
fpwm is the switching frequency of said switching element when the switching element current peak of said switching element is controlled.

8. A switching power supply device which converts an input voltage into a desired direct-current voltage and outputs the direct-current voltage, said switching power supply device comprising:
a power transformer including a primary winding, a secondary winding, and an auxiliary winding;
a switching element which is connected to said primary winding and performs a switching operation to repeatedly supply and stop supplying a first direct-current voltage to said primary winding;
an output voltage generation circuit which converts, into a second direct-current voltage, an alternating-current voltage induced in said secondary winding through the switching operation of said switching element, and supplies the second direct-current voltage to a load;
a transformer reset detection circuit which monitors a voltage signal of said auxiliary winding and generates a transformer reset signal according to a decrease in the voltage signal of said auxiliary winding which occurs when a secondary-side current finishes flowing through said secondary winding;
a secondary-side on-time signal generation circuit which generates a secondary-side on-time signal indicating a secondary-side on-time that is a time period from when said switching element is turned off to when the transformer reset signal is generated;
a feedback control circuit which generates a feedback signal corresponding to a voltage level of the second direct-current voltage;
a switching element drive circuit which controls the switching operation by supplying said switching element with a control signal corresponding to the feedback signal;
a switching frequency measuring circuit which generates a switching frequency signal proportional to a switching frequency of the control signal; and
an output voltage correcting signal generation circuit which generates an output voltage correcting signal from the switching frequency signal and the secondary-side on-time signal, and supplies the output voltage correcting signal to said feedback control circuit.
